(19) United States
(12) Patent Application Publication
(10) Pub. No.: US 2003/0217356 A1
(43) Pub. Date: Nov. 20, 2003

(54) Register allocation for program execution analysis

(76) Inventors: Leonid Baraz, Kiryat-Ata (IL); Tevi Devor, Zichron Yaacov (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/043,474

(22) Filed: Jan. 10, 2002

(51) Int. Cl. G06F 9/45

(52) U.S. Cl. 717/158; 717/140

(57) ABSTRACT

One or more instructions of a program are analyzed. The program is modified to expand a register set for a routine in the program.

### BACKGROUND OF THE INVENTION

1. Field of the Invention

The present invention relates generally to the field of computer systems. More particularly, the present invention relates to the field of program analysis for computer systems.

2. Description of Related Art

Typical dynamic instrumenters and dynamic optimizers analyze the execution of a computer program by modifying the program, for example, to gather data about how the program behaves as the program is executed. The gathered data may then be used, for example, to help optimize the execution speed of the program and/or memory usage by the program.

A typical instrumenter or optimizer allocates its own registers to store and/or process data in a manner that is transparent to the program. The instrumenter or optimizer may either save and restore registers being used by the program or allocate free registers.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary computer system that performs register allocation for program execution analysis;

FIG. 2 illustrates, for one embodiment, a flow diagram to allocate one or more registers for program execution analysis;

FIG. 3 illustrates, for one embodiment, an exemplary allocation of an expanded register set for a caller routine and of an expanded register set for a called routine called by the caller routine;

FIG. 4 illustrates, for one embodiment, a flow diagram to identify a sequence of one or more register moves for the flow diagram of FIG. 2;

FIG. 5 illustrates, for one embodiment, a flow diagram to define a move chain for the flow diagram of FIG. 4; and

FIG. 6 illustrates, for one embodiment, a flow diagram to identify a sequence of one or more register moves based on one or more defined move chains for the flow diagram of FIG. 4.

### DETAILED DESCRIPTION

The following detailed description sets forth an embodiment or embodiments in accordance with the present invention for register allocation for program execution analysis. In the following description, details are set forth such as specific algorithms, etc., in order to provide a thorough understanding of the present invention. It will be evident, however, that the present invention may be practiced without these details. In other instances, well-known computer components, etc., have not been described in particular detail so as not to obscure the present invention.

Exemplary Computer System

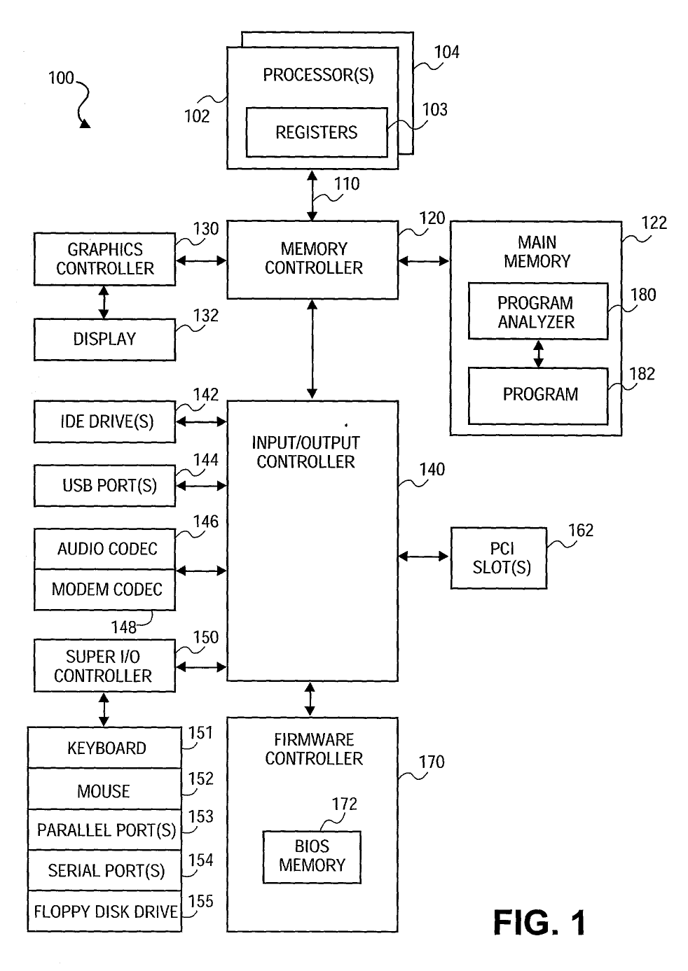

FIG. 1 illustrates an exemplary computer system 100 to perform register allocation for program execution analysis. Although described in the context of computer system 100, the present invention may be used with any suitable computer system comprising any suitable one or more devices.

As illustrated in FIG. 1, computer system 100 comprises processors 102 and 104. Processor 102 for one embodiment comprises a plurality of registers 103 to store data and/or instructions, for example, as processor 102 executes one or more programs each defined by one or more instructions. Processor 104 for one embodiment may similarly comprise registers. Processors 102 and 104 may each comprise any suitable processor architecture such as, for example, an Intel® 32-bit architecture or an Intel® 64-bit architecture as defined by Intel® Corporation of Santa Clara, Calif. Processor 102 and/or 104 for one embodiment may each comprise an Itanium® processor manufactured by Intel® Corporation. Although described in the context of two processors 102 and 104, computer system 100 for other embodiments may comprise one, three, or more processors.

Computer system 100 also comprises a memory controller 120. Processors 102 and 104 and memory controller 120 for one embodiment are each coupled to one another by a processor bus 110. Memory controller 120 may comprise any suitable circuitry formed on any suitable one or more integrated circuit chips.

Memory controller 120 may comprise any suitable interface controllers to provide for any suitable communication link to processor bus 110 and/or to any suitable device or component in communication with memory controller 120. Memory controller 120 for one embodiment may provide suitable arbitration, buffering, and coherency management for each interface.

Memory controller 120 provides an interface to processor 102 and/or processor 104 over processor bus 110. For one embodiment, processor 102 or 104 may alternatively be combined with memory controller 120 to form a single integrated circuit chip. Memory controller 120 for one embodiment also provides an interface to a main memory 122, a graphics controller 130, and an input/output (I/O) controller 140.

Main memory 122 is coupled to memory controller 120 to load and store data and/or instructions, for example, for computer system 100. Main memory 122 may comprise any suitable memory, such as suitable dynamic random access memory (DRAM) for example.

Graphics controller 130 is coupled to memory controller 120 to control the display of information on a suitable display 132, such as a cathode ray tube (CRT) or liquid crystal display (LCD) for example, coupled to graphics controller 130. Memory controller 120 for one embodiment interfaces with graphics controller 130 through an accelerated graphics port (AGP). Graphics controller 130 for one embodiment may alternatively be combined with memory controller 120 to form a single integrated circuit chip.

I/O controller 140 is coupled to memory controller 120 to provide an interface to one or more I/O devices coupled to I/O controller 140. I/O controller 140 may comprise any suitable interface controllers to provide for any suitable communication link to memory controller 120 and/or to any suitable device in communication with I/O controller 140. I/O controller 140 for one embodiment may provide suitable arbitration and buffering for each interface.

For one embodiment, I/O controller 140 may provide an interface to one or more suitable integrated drive electronics (IDE) drives 142, such as a hard disk drive (HDD), a compact disc (CD) drive, and/or a digital versatile disc (DVD) drive, for example, to store data and/or instructions, for example. I/O controller 140 for one embodiment may also provide an interface to one or more suitable universal serial bus (USB) devices through one or more USB ports 144, an audio coder/decoder (codec) 146, and a modem codec 148. I/O controller 140 for one embodiment may also provide an interface through a super I/O controller 150 to a keyboard 151, a mouse 152 or any other suitable cursor control device, one or more suitable devices, such as a printer for example, through one or more parallel ports 153, one or more suitable devices through one or more serial ports 154, and a floppy disk drive 155. I/O controller 140 for one embodiment may further provide an interface to one or more suitable peripheral component interconnect (PCI) devices coupled to I/O controller 140 through one or more PCI slots 162 on a PCI bus.

I/O controller 140 is also coupled to a firmware controller 170 to provide an interface to firmware controller 170. Firmware controller 170 comprises a basic input/output system (BIOS) memory 172 to store suitable system and/or video BIOS software. BIOS memory 172 may comprise any suitable non-volatile memory, such as a flash memory for example.

Program Analyzer

Processor 102, for example, executes a program analyzer 180 to analyze how a program 182 is executed by processor 102. For one embodiment, program analyzer 180, when executed by processor 102, may analyze the execution of program 182 by processor 102 by modifying program 182 to gather data about how program 182 behaves as program 182 is executed by processor 102. Program analyzer 180 may gather any suitable data about the execution of program 182 in any suitable manner. Program analyzer 180 and/or any other program may then use gathered data about the execution of program 182 for any suitable purpose. The gathered data for one embodiment may be used, for example, by a compiler, interpreter, optimizer, and/or code generator for program 182 to help optimize the execution speed of program 182 and/or memory usage by program 182. The gathered data for another embodiment may be used, for example, by a program understanding and browsing tool to help a programmer better understand how program 182 behaves.

Program analyzer 180 for one embodiment may be a dynamic instrumenter. Program analyzer 180 for another embodiment may be part of a dynamic optimizer.

Program analyzer 180 for one embodiment may comprise any suitable instructions in any suitable language that may be read and performed by processor 102 in any suitable manner. Program analyzer 180 may be stored on and executed from any suitable medium. Program analyzer 180 may be stored, for example, on one or more compact discs (CDs), one or more digital versatile discs (DVDs), one or more hard disks, and/or one or more floppy disks. Processor 102 may then retrieve program analyzer 180 from IDE drive(s) 142 and/or floppy disk drive 155 to execute program analyzer 180. Processor 102 for another embodiment may retrieve program analyzer 180 from a suitable medium, such as a server for example, that may be coupled to computer system 100 through a suitable communication link using, for example, modem codec 148 or a suitable network interface adapter coupled to USB port(s) 144 or to PCI slot(s) 162, for example. In retrieving program analyzer 180 to execute program analyzer 180, processor 102 for one embodiment may store at least a portion of program analyzer 180 in main memory 122 as illustrated in FIG. 1.

Although described in the context of computer system 100, program analyzer 180 may comprise any suitable instructions that may be stored on any suitable machine-readable medium. The instructions of program analyzer 180 may be in any suitable language that may be directly or indirectly performed by any suitable machine.

Register Allocation

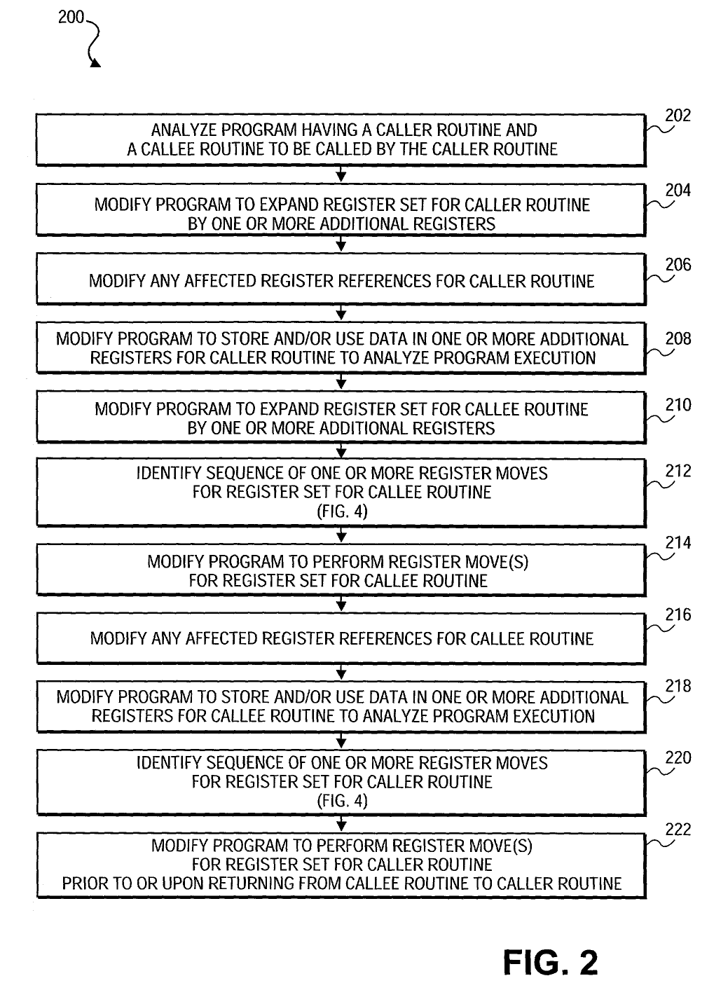

Program analyzer 180 for one embodiment modifies program 182 to allocate one or more registers for one or more routines of program 182 to store and/or process data about how program 182 behaves when program 182 is executed. Program analyzer 180 for one embodiment may modify program 182 in a manner that is transparent to program 182. Program analyzer 180 for one embodiment may modify program 182 in accordance with a flow diagram 200 of FIG. 2.

For block 202 of FIG. 2, program analyzer 180 analyzes one or more instructions of program 182. Program 182 for one embodiment may comprise any suitable instructions in any suitable language that may be read and performed by processor 102 in any suitable manner. Program 182 may be defined, for example, in a suitable high-level programming language or a suitable machine-level language. Program 182 for one embodiment comprises instructions defining one or more caller routines and instructions defining one or more callee routines each to be called by a caller routine. For one embodiment, a routine that is called by a routine and that calls a routine is both a caller routine and a callee routine, noting a routine may possibly call itself or be called by itself. A routine of program 182 may be a subroutine, a function, or a procedure, for example.

Program 182 for one embodiment comprises one or more instructions such that program 182, when executed by processor 102, allocates a set of one or more registers 103 for each of one or more caller routines and/or for each of one or more callee routines. Program 182 may allocate any suitable number of one or more registers 103 for any suitable purpose in any suitable manner in allocating a register set for each of one or more caller and/or callee routines of program 182. For one embodiment, a register set allocated for a routine may comprise one or more local registers and/or one or more output registers for the routine. A routine for one embodiment may use a local register to store and/or process input data passed to the routine from a caller routine and/or to store and/or process data local to the routine. A routine for one embodiment may use an output register to store and/or process data that is to be passed to a callee routine in calling the callee routine and/or to store and/or process data that is to be passed from the callee routine to the caller routine in returning from the callee routine.

Program 182 for one embodiment, after having been compiled, may identify a register in a register set for one or more routines with a virtual register identifier. Register access then occurs by renaming virtual register identifiers referenced in instructions of program 182 into physical registers. For another embodiment, program 182 may be created or compiled to reference physical registers directly.

Program 182 for one embodiment may comprise instructions in accordance with the Intel® 64-bit architecture programming model in which a register stack frame is allocated for each of one or more procedures.

Program analyzer 180 may analyze program 182 in any suitable manner. Program analyzer 180 for one embodiment may analyze program 182 to identify a caller routine of program 182 and/or a callee routine of program 182 to be called by the caller routine. Program analyzer 180 for one embodiment may analyze program 182 to identify how program 182 is to allocate one or more registers 103 for the identified caller routine and/or for the identified callee routine. Program analyzer 180 for one embodiment may analyze program 182 to identify data to store and/or process to analyze how program 182 behaves when executed by processor 102.

For block 204 of FIG. 2, program analyzer 180 modifies program 182 to expand a register set for an identified caller routine of program 182 by one or more additional registers 103.

Program analyzer 180 may modify program 182 in any suitable manner to expand the register set for the caller routine. Program analyzer 180 for one embodiment may modify one or more register allocation instructions of program 182 to allocate one or more additional registers in the register set for the caller routine in allocating the register set for the caller routine. Program analyzer 180 for another embodiment may insert one or more suitable instructions in program 182 to allocate one or more additional registers in the register set for the caller routine.

Program analyzer 180 may modify program 182 to expand the register set for the caller routine in any suitable manner by any suitable number of one or more registers for any suitable purpose. Program analyzer 180 for one embodiment may modify program 182 to allocate one or more additional registers for the caller routine to store and/or process data local to the execution of the caller routine and/or one or more additional registers for the caller routine to store and/or process data that is to be passed to a callee routine in calling the callee routine and/or passed from the callee routine to the caller routine in returning from the callee routine. In modifying program 182, program analyzer 180 for one embodiment may modify the original allocation of one or more registers for the caller routine. Program analyzer 180 for one embodiment may modify program 182 to allocate one or more registers originally defined by program 182 to be allocated for the caller routine as one or more additional registers for use in analyzing the execution of program 182 and to allocate one or more new registers for the one or more displaced registers.

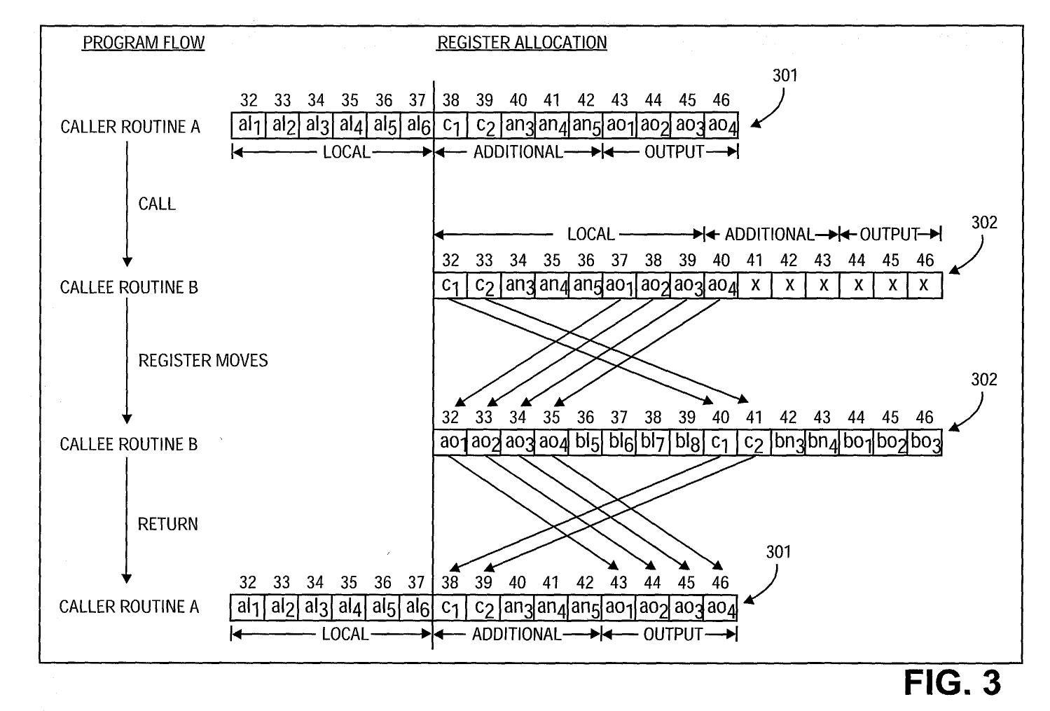

FIG. 3 illustrates, for one embodiment, an exemplary allocation of an expanded register set for a caller routine and of an expanded register set for a callee routine called by the caller routine of program 182. As illustrated in FIG. 3, a caller routine A has an expanded register set 301 comprising 15 registers having virtual register identifiers 32 through 46.

Of registers 32-46, registers 32-37 are local registers to store input and/or local data al₁, al₂, al₃, al₄, al₅, and al₆, respectively, for caller routine A, and registers 43-46 are output registers to store output data ao₁, ao₂, ao₃, and ao₄, respectively, for caller routine A. Prior to being modified by program analyzer 180, program 182 would have allocated for caller routine A a register set having 10 registers: 6 local registers and 4 output registers. Program 182 for one embodiment would have allocated registers 32-41 for this purpose.

Program analyzer 180 for block 204 modifies program 182 to allocate 5 registers in addition to the 10 registers to be allocated for caller routine A. Program analyzer 180 for one embodiment, as illustrated in FIG. 3, allocates the additional registers between the set of 6 local registers and the set of 4 output registers for caller routine A. Program analyzer 180 for one embodiment therefore modifies the allocation of the output registers for caller routine A from registers 38-41 to registers 43-46 to allocate registers 38-42 for the additional 5 registers. Registers 38-39 are to store data c₁ and c₂, respectively, which are to be passed to a callee routine B when called by caller routine A and/or passed from callee routine B when returning to caller routine A. Registers 40-42 are to store data an₃, an₄, and an₅, respectively, which are local to the execution of caller routine A.

For block 206, program analyzer 180 for one embodiment may modify any affected register references for the caller routine. For one embodiment where the modification of program 182 for block 204 may modify the original allocation of one or more registers for the caller routine, program analyzer 180 modifies any references in program 182 to a register the allocation of which has been modified to account for the modified allocation. Referring to the example of FIG. 3 where program analyzer 180 for one embodiment modifies the allocation of the output registers for caller routine A from registers 38-41 to registers 43-46, program analyzer 180 for block 206 modifies any references in program 182 to registers 38, 39, 40, and 41 for caller routine A to refer to registers 43, 44, 45, and 46, respectively.

For block 208, program analyzer 180 modifies program 182 to store and/or use data in one or more additional registers for the caller routine to help analyze the execution of program 182. Program analyzer 180 may modify program 182 in any suitable manner for block 208. Program analyzer 180 for one embodiment may modify one or more instructions of program 182 and/or insert one or more instructions in program 182 to store and/or use data in one or more additional registers for the caller routine in any suitable manner.

For block 210, program analyzer 180 modifies program 182 to expand a register set for an identified callee routine of program 182 by one or more additional registers 103.

Program analyzer 180 may modify program 182 in any suitable manner to expand the register set for the callee routine. Program analyzer 180 for one embodiment may modify one or more register allocation instructions of program 182 to allocate one or more additional registers in the register set for the callee routine in allocating the register set for the callee routine. Program analyzer 180 for another embodiment may insert one or more suitable instructions in program 182 to allocate one or more additional registers in the register set for the callee routine.

Program analyzer 180 may modify program 182 to expand the register set for the callee routine in any suitable manner by any suitable number of one or more registers for any suitable purpose. Program analyzer 180 for one embodiment may modify program 182 to allocate one or more additional registers for the callee routine to store and/or process data local to the execution of the callee routine and/or one or more additional registers for the callee routine to store and/or process data that is to be passed to the callee routine in calling the callee routine and/or passed from the callee routine to a caller routine in returning from the callee routine. In modifying program 182, program analyzer 180 for one embodiment may modify the original allocation of one or more registers for the callee routine. Program analyzer 180 for one embodiment may modify program 182 to allocate one or more registers originally defined by program 182 to be allocated for the callee routine as one or more additional registers for use in analyzing the execution of program 182 and to allocate one or more new registers for the one or more displaced registers.

Prior to being expanded by program analyzer 180, the register set for the callee routine for one embodiment may overlap at least a portion of the register set for the caller routine that is to call the callee routine. That is, the register set for the callee routine for one embodiment may include one or more registers of the register set for the caller routine. For one embodiment, the register set for the callee routine may include one or more output registers of the register set for the caller routine used to store output data to be passed to the callee routine and/or used to return data from the callee routine to the caller routine. Overlapping the register set for the caller routine with the register set for the callee routine in this manner helps to minimize any spilling and filling of registers when the caller routine calls the callee routine and/or when the callee routine returns to the caller routine. The register set for the callee routine for one embodiment may include all output registers of the register set for the caller routine used to store output data to be passed to the callee routine and/or used to return data from the callee routine to the caller routine.

The register set for the callee routine for one embodiment may not include one or more output registers of the register set for the caller routine used to store output data to be passed to the callee routine. Program 182 may then move the output data in one or more such output registers to corresponding one or more registers in the register set for the callee routine to pass the output data to the callee routine. The register set for the callee routine for one embodiment may not include any output registers of the register set for the caller routine used to store output data to be passed to the callee routine and/or used to return data from the callee routine to the caller routine.

Program analyzer 180 for one embodiment may expand the register set for the callee routine by one or more additional registers such that one or more registers added to expand the register set for the callee routine overlap one or more registers added to expand the register set for the caller routine and/or one or more output registers of the original and/or expanded register set for the caller routine. In this manner, data may be passed to the callee routine using the registers added in expanding the register set for the callee routine. Program analyzer 180 for one embodiment may expand the register set for the callee routine by one or more additional registers such that one or more registers added to expand the register set for the callee routine do not include one or more registers added to expand the register set for the caller routine and/or one or more output registers of the original and/or expanded register set for the caller routine.

Referring to the example of FIG. 3, callee routine B has an expanded register set 302 comprising 15 registers having virtual register identifiers 32 through 46.

Of registers 32-46, registers 32-39 are local registers to store input and/or local data bl₁, bl₂, bl₃, bl₄, bl₅, bl₆, bl₇, and bl₈, respectively, for callee routine B, and registers 44-46 are output registers to store output data bo₁, bo₂, and bo₃, respectively, for callee routine B. Prior to being modified by program analyzer 180, program 182 would have allocated for callee routine B a register set having 11 registers: 8 local registers and 3 output registers. Program 182 for one embodiment would have allocated registers 32-42 for this purpose. Program 182 for one embodiment would have allocated local registers 32-35 for callee routine B to overlap output registers 38-41 for caller routine A to pass output data ao₁, ao₂, ao₃, and ao₄ to callee routine B.

Program analyzer 180 for block 210 modifies program 182 to allocate 4 registers in addition to the 11 registers to be allocated for callee routine B. Program analyzer 180 for one embodiment allocates the additional registers between the set of 8 local registers and the set of 3 output registers for callee routine B. Program analyzer 180 for one embodiment therefore modifies the allocation of the output registers for callee routine B from registers 40-42 to registers 44-46 to allocate registers 40-43 for the additional 4 registers. Registers 40-41 are to store data c₁ and c₂, respectively, which are to be passed to callee routine B when called by caller routine A and/or passed from callee routine B when returning to caller routine A. Registers 42-43 are to store data bn₃, and bn₄, respectively, which are local to the execution of callee routine B.

For block 212, program analyzer 180 for one embodiment may identify a sequence of one or more register moves, if any, for the register set for the callee routine. Program analyzer 180 for one embodiment may identify a sequence of one or more register moves to move data between registers of the register set for the callee routine. Program analyzer 180 may identify data in one or more registers of the register set for the callee routine is to be moved, for example, because of the expansion of the register set for the caller routine and/or because of the expansion of the register set for the callee routine.

As one example where the register set for the caller routine comprises one or more output registers that overlap one or more registers of the register set for the callee routine, the expansion of the register set for the caller routine may modify which registers of the register set for the callee routine will have output data from the caller routine when the caller routine calls the callee routine. Program analyzer 180 may therefore identify one or more register moves to move any passed output data to the one or more local registers allocated by the callee routine to store the passed output data.

As another example where the register set for the callee routine comprises one or more local registers, for example, that overlap one or more additional registers of the expanded register set for the caller routine, where program analyzer 180 is to expand the register set for the callee routine, and where data stored in one or more additional registers for the caller routine are to be passed to the callee routine, program analyzer 180 may identify one or more register moves to move any such passed data to one or more additional registers allocated by the callee routine to store the passed data.

Referring to the example of FIG. 3, program analyzer 180 identifies that output data ao₁, ao₂, ao₃, and ao₄ is to be moved from registers 37-40, respectively, of register set 302 to registers 32-35, respectively, of register set 302 and that data c₁ and c₂ is to be moved from registers 32-33, respectively, of register set 302 to registers 40-41, respectively, of register set 302.

Because moving data from one register to another register will overwrite any data in that other register, program analyzer 180 for one embodiment may identify a sequence of one or more register moves to avoid overwriting data that is also to be moved. Referring to the example of FIG. 3, moving output data ao₂ from register 38 to register 33 will overwrite data c₂ which is to be moved from register 33 to register 41. Program analyzer 180 may therefore identify a sequence of register moves in which data c₂ is moved from register 33 to register 41 before output data ao₂ is moved from register 38 to register 33. Program analyzer 180 may identify any suitable sequence of any suitable one or more register moves in any suitable manner for block 212.

For block 214, program analyzer 180 for one embodiment may modify program 182 to perform any register move(s) for the register set of the callee routine. Program analyzer 180 for one embodiment may modify one or more instructions of program 182 and/or insert one or more instructions in program 182 to perform the sequence of register move(s) for the register set of the callee routine as identified for block 212. Program analyzer 180 for one embodiment may modify program 182 to perform the register move(s) for the register set of the callee routine upon allocating the expanded register set for the callee routine.

For block 216, program analyzer 180 for one embodiment may modify any affected register references for the callee routine. For one embodiment where the modification of program 182 for block 210 may modify the original allocation of one or more registers for the callee routine, program analyzer 180 modifies any references in program 182 to a register the allocation of which has been modified to account for the modified allocation. Referring to the example of FIG. 3 where program analyzer 180 for one embodiment modifies the allocation of the output registers for callee routine B from registers 40-42 to registers 44-46, program analyzer 180 for block 216 modifies any references in program 182 to registers 40, 41, and 42 for callee routine B to refer to registers 44, 45, and 46, respectively.

For block 218, program analyzer 180 modifies program 182 to store and/or use data in one or more additional registers for the callee routine to help analyze the execution of program 182. Program analyzer 180 may modify program 182 in any suitable manner for block 218. Program analyzer 180 for one embodiment may modify one or more instructions of program 182 and/or insert one or more instructions in program 182 to store and/or use data in one or more additional registers for the callee routine in any suitable manner.

For block 220, program analyzer 180 for one embodiment may identify a sequence of one or more register moves, if any, for the register set for the caller routine. Program analyzer 180 may identify data in one or more registers is to be moved, for example, because of the modification of program 182 for block 214 to perform one or more register moves for the register set for the callee routine.

As one example where passed output data is moved from one or more registers of the register set for the callee routine that overlap one or more output registers of the register set for the caller routine, program analyzer 180 may identify one or more register moves to move any such output data back to the one or more registers of the register set for the callee routine that overlap one or more output registers of the register set for the caller routine. The callee routine for one embodiment may comprise one or more instructions to modify any such output data passed from the caller routine.

As another example where passed data is moved from one or more registers of the register set for the callee routine that overlap one or more additional registers for the caller routine, program analyzer 180 may identify one or more register moves to move any such data back to the one or more registers of the register set for the callee routine that overlap one or more additional registers of the register set for the caller routine. Program analyzer 180 for one embodiment may modify the callee routine for block 218 to modify any such data passed from the caller routine.

As another example where the callee routine is to return data to the caller routine in one or more registers of the register set for the caller routine that overlap one or more registers of the register set for the callee routine, program analyzer 180 may identify one or more register moves to move any such return data to the one or more registers of the register set for the callee routine that overlap the one or more registers of the register set for the caller routine that are allocated for the return data. The callee routine for one embodiment may comprise one or more instructions to create or modify data for return to the caller routine in one or more output registers of the register set for the caller routine. Program analyzer 180 for one embodiment may modify the callee routine for block 218 to create or modify data for return to the caller routine in one or more additional registers of the register set for the caller routine.

Referring to the example of FIG. 3, program analyzer 180 identifies that output data ao₁, ao₂, ao₃, and ao₄ is to be moved from registers 32-35, respectively, of register set 302 to registers 37-40, respectively, of register set 302 and that data c₁ and c₂ is to be moved from registers 40-41, respectively, of register set 302 to registers 32-33, respectively, of register set 302. When callee routine B returns to caller routine A, output data ao₁, ao₂, ao₃, and ao₄ and data c₁ and c₂ will then be stored in the registers of register set 301 that have been allocated to store such data.

Because moving data from one register to another register will overwrite any data in that other register, program analyzer 180 for one embodiment may identify a sequence of one or more register moves to avoid overwriting data that is also to be moved. Program analyzer 180 may identify any suitable sequence of any suitable one or more register moves in any suitable manner for block 220.

For block 222, program analyzer 180 for one embodiment may modify program 182 to perform any register move(s) for the register set of the caller routine prior to or upon returning from the callee routine to the caller routine. Program analyzer 180 for one embodiment may modify one or more instructions of program 182 and/or insert one or more instructions in program 182 to perform the sequence of register move(s) for the register set of the caller routine as identified for block 220.

Although described in the context of identifying one caller routine and one callee routine, program analyzer 180 for one embodiment may identify one or more caller routines and/or one or more callee routines of program 182 and expand a register set for one or more identified routines in accordance with flow diagram 200 of FIG. 2.

Program analyzer 180 for one embodiment may both analyze and modify program 182 prior to execution of program 182 by processor 102, for example. Program analyzer 180 for another embodiment may analyze program 182 prior to execution of program 182 by processor 102, for example, and modify program 182 as program 182 is executed by processor 102, for example. Program analyzer 180 for another embodiment may both analyze and modify program 182 as program 182 is executed by processor 102, for example.

Program 182 may be stored on and analyzed and/or executed from any suitable medium. Program 182 may be stored, for example, on one or more compact discs (CDs), one or more digital versatile discs (DVDs), one or more hard disks, and/or one or more floppy disks. Processor 102 may then retrieve program 182 from IDE drive(s) 142 and/or floppy disk drive 155 to analyze and/or execute program 182. Processor 102 for another embodiment may retrieve program 182 from a suitable medium, such as a server for example, that may be coupled to computer system 100 through a suitable communication link using, for example, modem codec 148 or a suitable network interface adapter coupled to USB port(s) 144 or to PCI slot(s) 162, for example. In retrieving program 182 to analyze and/or execute program 182, processor 102 for one embodiment may store at least a portion of program 182 in main memory 122 as illustrated in FIG. 1.

Program analyzer 180 for one embodiment, when executed by processor 102 for example, may modify program 182 as stored in a volatile memory, such as main memory 122 for example, and/or as stored in a non-volatile memory, such as a hard disk for example. Program analyzer 180 for one embodiment, when executed by processor 102 for example, may modify program 182 without modifying any stored version of program 182 by modifying one or more instructions after the instruction is read from main memory 122, for example, for execution by processor 102, for example. Program analyzer 180 for one embodiment, when executed by processor 102 for example, may modify program 182 without modifying any stored version of program 182 by inserting one or more instructions into an instruction stream for program 182 as the instruction stream is read from main memory 122, for example, for execution by processor 102, for example.

Register Move(s) Sequence Identification

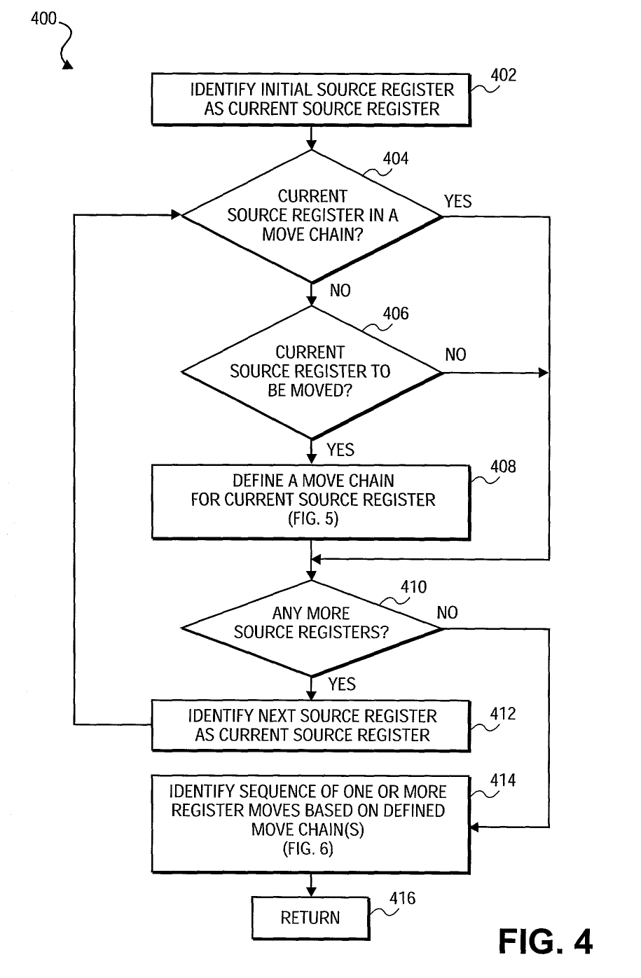

Program analyzer 180 for one embodiment for blocks 212 and 220 of FIG. 2 may identify a sequence of one or more register moves for a register set in accordance with a flow diagram 400 of FIG. 4.

For block 402 of FIG. 4, program analyzer 180 identifies an initial source register of an expanded register set as a current source register. Referring to the example of FIG. 3, program analyzer 180 may identify, for example, a first register in expanded register set 302, that is register 32, as the current source register.

For block 404, program analyzer 180 identifies whether the current source register is in a move chain. If not, program analyzer 180 for block 406 identifies whether the current source register is to be moved. If so, program analyzer 180 for block 408 defines a move chain for the current source register. Referring to the example of FIG. 3, register 32 is not in a move chain and is to be moved to register 40 of expanded register set 302. Program analyzer 180 therefore builds a move chain for register 32.

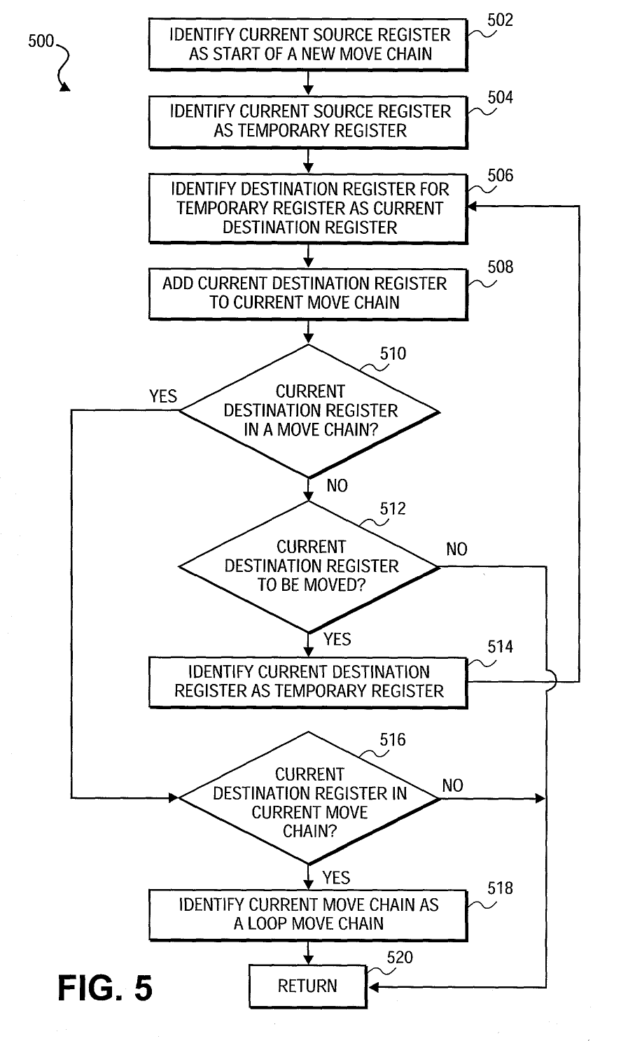

A move chain identifies a sequence of one or more moves each from a source register to a destination register where each destination register in the sequence, except for the last destination register in the sequence, also serves as the source register for the next move in the sequence. Program analyzer 180 may define a move chain for the current source register in any suitable manner. Program analyzer 180 for one embodiment may define a move chain in accordance with a flow diagram 500 of FIG. 5.

For block 502 of FIG. 5, program analyzer 180 identifies the current source register as the start of a new move chain. Referring to the example of FIG. 3, program analyzer 180 starts a new move chain with register 32 of expanded register set 302.

For block 504, program analyzer 180 identifies the current source register as a temporary register. Program analyzer 180 for block 506 identifies the destination register for the temporary register as the current destination register and for block 508 adds the current destination register to the current move chain. Referring to the example of FIG. 3, register 40 of expanded register set 302 is the destination register for register 32. Program analyzer 180 therefore adds register 40 to the current move chain.

For block 510, program analyzer 180 identifies whether the current destination register was in a move chain, including the current move chain. If not, program analyzer 180 for block 512 identifies whether the current destination register is to be moved. If so, program analyzer 180 for block 514 identifies the current destination register as the temporary register and repeats blocks 506, 508, 510, 512, and/or 514 to add one or more other destination registers to the current move chain until program analyzer 180 identifies for block 510 that the current destination register was in a move chain or identifies for block 512 that the current destination register is not to be moved.

If program analyzer 180 identifies for block 510 that the current destination register was in a move chain, program analyzer 180 for block 516 identifies whether the current destination register was in the current move chain. If so, program analyzer 180 for block 518 identifies the current move chain as a loop move chain and returns the current move chain for block 520. If program analyzer 180 identifies for block 516 that the current destination register was not in the current move chain or identifies for block 512 that the current destination register is not to be moved, program analyzer 180 returns the current move chain for block 520.

Referring to the example of FIG. 3, register 40 of expanded register set 302 is to be moved to register 35 of expanded register set 302. Because register 35 was not in any move chain, including the current move chain, and is not to be moved, program analyzer 180 adds register 35 to the current move chain and returns. The defined move chain for register 32 is therefore (32, 40, 35).

Regardless of whether program analyzer 180 identifies the current source register is in a move chain for block 404, identifies the current source register is not to be moved for block 406, or defines a move chain for the current source register for block 408, program analyzer 180 for block 410 identifies whether any more source registers are to be analyzed. If so, program analyzer 180 for block 412 identifies the next source register as the current source register and repeats blocks 404, 406, 408, 410, and/or 412 to possibly define a move chain for each of one or more other source registers until program analyzer 180 identifies for block 410 that no more source registers are to be analyzed.

Referring to the example of FIG. 3, program analyzer 180 for one embodiment, after analyzing register 32 of expanded register set 302, may analyze each register of expanded register set 302, for example, in order of their virtual register identifiers. Although described as analyzing the registers of expanded register set 302 in order of their virtual register identifiers, program analyzer 180 may analyze registers of a register set in any suitable order.

Because register 33 is not in the move chain defined for register 32 and because register 33 is to be moved to register 41, program analyzer 180 defines the move chain (33, 41), noting register 41 is not to be moved.

Because register 34 is not to be moved, program analyzer 180 does not define a move chain for register 34.

Because register 35 is in the move chain defined for register 32, program analyzer 180 does not define a move chain for register 35.

Because register 36 is not to be moved, program analyzer 180 does not define a move chain for register 36.

Because register 37 is not in the move chains defined for registers 32 and 33 and because register 37 is to be moved to register 32, program analyzer 180 defines the move chain (37, 32), noting register 32 is in the move chain defined for register 32.

Because register 38 is not in the move chains defined for registers 32, 33, and 37 and because register 38 is to be moved to register 33, program analyzer 180 defines the move chain (38, 33), noting register 33 is in the move chain defined for register 33.

Because register 39 is not in the move chains defined for registers 32, 33, 37, and 38 and because register 39 is to be moved to register 34, program analyzer 180 defines the move chain (39, 34), noting register 34 is not to be moved.

Because register 40 is in the move chain defined for register 32, program analyzer 180 does not define a move chain for register 40.

Because register 41 is in the move chain defined for register 33, program analyzer 180 does not define a move chain for register 41.

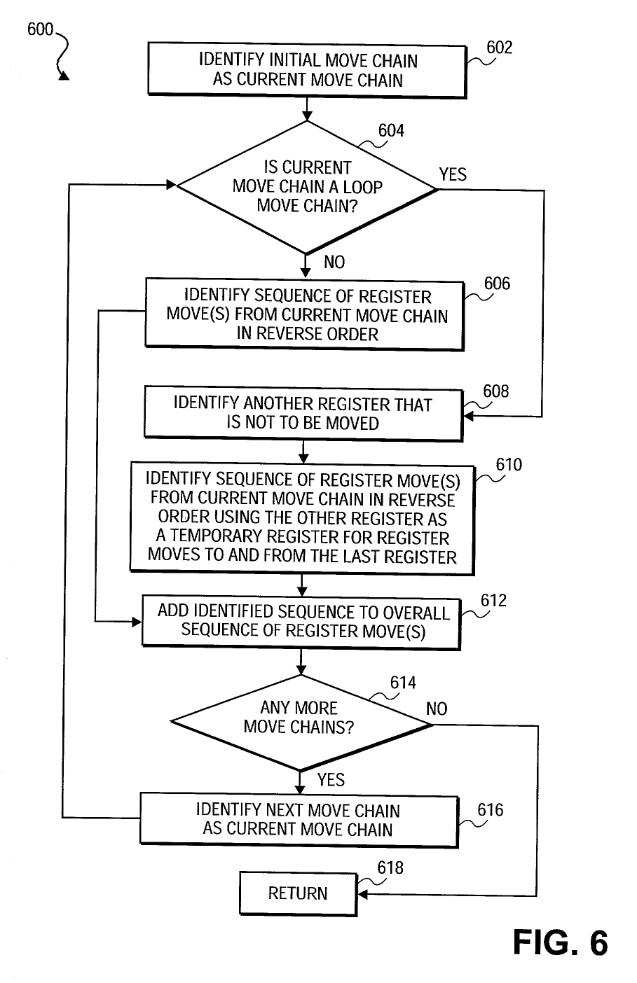

When program analyzer 180 identifies for block 410 that no more source registers are to be analyzed, program analyzer 180 for block 414 identifies a sequence of one or more register moves based on the one or more move chains defined for block 408 and for block 416 returns the identified sequence of register move(s). Program analyzer 180 may identify a sequence of one or more register moves based on the one or more defined move chains for block 414 in any suitable manner. Program analyzer 180 for one embodiment may identify a sequence of one or more register moves in accordance with a flow diagram 600 of FIG. 6.

For block 602 of FIG. 6, program analyzer 180 identifies an initial move chain as a current move chain. Referring to the example of FIG. 3, program analyzer 180 for one embodiment may have defined the following move chains for expanded register set 302: (32, 40, 35), (33, 41), (37, 32), (38, 33), and (39, 34). Program analyzer 180 may identify, for example, a first move chain, that is move chain (32, 40, 35), as the current move chain.

For block 604, program analyzer 180 identifies whether the current move chain is a loop move chain. If not, program analyzer 180 for block 606 identifies a sequence of one or more register moves from the current move chain in reverse order and for block 612 adds the identified sequence to an overall sequence of one or more register moves.

Referring to the example of FIG. 3, program analyzer 180 identifies move chain (32, 40, 35) is not a loop chain and identifies the following sequence of register moves from move chain (32, 40, 35) in reverse order: (1) register 40 to register 35 and (2) register 32 to register 40. As the overall sequence of one or more register moves is empty, program analyzer 180 starts the overall sequence of one or more register moves with this identified sequence.

If program analyzer 180 identifies the current move chain is a loop move chain for block 604, program analyzer 180 for block 608 identifies another register that is not to be moved and for block 610 identifies a sequence of one or more register moves from the current move chain in reverse order using the other register identified for block 608 as a temporary register for register moves to and from the last register in the current move chain. Program analyzer 180 may identify the other register for block 608 in any suitable manner. Program analyzer 180 for one embodiment may identify for block 608 the last register in another move chain that is not a loop move chain. Program analyzer 180 for block 612 adds the sequence of one or more register moves identified for block 610 to an overall sequence of one or more register moves.

Program analyzer 180 for block 614 identifies whether any more move chains are to be analyzed. If so, program analyzer 180 for block 616 identifies a next move chain as the current move chain and repeats blocks 604, 606, 608, 610, 612, 614, and/or 616 to add one or more register moves from one or more other move chains to the overall sequence of register move(s) until program analyzer 180 identifies for block 614 that no more move chains are to be analyzed.

Referring to the example of FIG. 3, program analyzer 180 identifies each move chain (33, 41), (37, 32), (38, 33), and (39, 34) is not a loop move chain and identifies the following sequences of one or more register moves for these move chains: register 33 to register 41, register 37 to register 32, register 38 to register 33, and register 39 to register 34. Program analyzer 180 adds each of these identified sequences to the overall sequence of register moves. The overall sequence of register moves is therefore:

(1) register 40 to register 35,

(2) register 32 to register 40,

(3) register 33 to register 41,

(4) register 37 to register 32,

(5) register 38 to register 33, and

(6) register 39 to register 34.

When program analyzer 180 identifies for block 614 that no more move chains are to be analyzed, program analyzer 180 for block 618 returns the overall sequence of register move(s).

Although described as performing flow diagrams 200, 400, 500, and 600 in accordance with an order of blocks as illustrated in FIGS. 2, 4, 5, and 6, respectively, program analyzer 180 for one or more other embodiments may perform suitable functions for blocks of flow diagrams 200, 400, 500, and/or 600 in any other suitable order. Program analyzer 180 for one or more other embodiments may also perform suitable functions for blocks of flow diagrams 200, 400, 500, and/or 600 in an overlapped manner.

In the foregoing description, the invention has been described with reference to specific exemplary embodiments thereof. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A machine-implemented method comprising:
analyzing one or more instructions of a program; and
modifying the program to expand a register set for a routine in the program.

2. The method of claim 1, comprising:
identifying one or more register moves for the expanded register set; and
modifying the program to perform the identified one or more register moves.

3. The method of claim 2, wherein the identifying comprises:
defining one or more move chains for the expanded register set, and
identifying a sequence of one or more register moves based on the defined one or more move chains.

4. The method of claim 1, wherein the modifying the program comprises modifying the program to expand a register set for a callee routine of the program.

5. The method of claim 4, comprising:
modifying the program to expand a register set for a caller routine that is to call the callee routine.

6. The method of claim 5, wherein the modifying the program to expand a register set for the callee routine comprises modifying the program to expand a register set that includes one or more registers of the register set for the caller routine.

7. The method of claim 5, comprising:
identifying one or more register moves for the register set of the caller routine; and
modifying the program to perform the identified one or more register moves prior to or upon returning from the callee routine to the caller routine.

8. The method of claim 5, comprising:
identifying a register move from a register added to the register set for the caller routine to a register added to the register set for the callee routine; and
modifying the program to perform the identified register move.

9. The method of claim 1, comprising:
modifying the program to store and/or use data in one or more registers added to the register set to help analyze execution of the program.

10. A machine-readable medium having instructions that, if executed by a machine, cause the machine to perform a method comprising:
analyzing one or more instructions of a program; and
modifying the program to expand a register set for a routine in the program.

11. The machine-readable medium of claim 10, wherein the method comprises:
identifying one or more register moves for the expanded register set; and
modifying the program to perform the identified one or more register moves.

12. The machine-readable medium of claim 11, wherein the identifying comprises:
defining one or more move chains for the expanded register set, and
identifying a sequence of one or more register moves based on the defined one or more move chains.

13. The machine-readable medium of claim 10, wherein the modifying the program comprises modifying the program to expand a register set for a callee routine of the program.

14. The machine-readable medium of claim 13, wherein the method comprises:
modifying the program to expand a register set for a caller routine that is to call the callee routine.

15. The machine-readable medium of claim 14, wherein the modifying the program to expand a register set for the callee routine comprises modifying the program to expand a register set that includes one or more registers of the register set for the caller routine.

16. The machine-readable medium of claim 14, wherein the method comprises:
identifying one or more register moves for the register set of the caller routine; and
modifying the program to perform the identified one or more register moves prior to or upon returning from the callee routine to the caller routine.

17. The machine-readable medium of claim 14, wherein the method comprises:
identifying a register move from a register added to the register set for the caller routine to a register added to the register set for the callee routine; and
modifying the program to perform the identified register move.

18. The machine-readable medium of claim 10, wherein the method comprises:
modifying the program to store and/or use data in one or more registers added to the register set to help analyze execution of the program.

19. A system comprising:
a processor to execute instructions; and
a medium having instructions to analyze one or more instructions of a program and to modify the program to expand a register set for a routine in the program.

20. The system of claim 19, the medium having instructions to identify one or more register moves for the expanded register set and to modify the program to perform the identified one or more register moves.

21. The system of claim 20, the medium having instructions to define one or more move chains for the expanded register set and to identify a sequence of one or more register moves based on the defined one or more move chains.

22. The system of claim 19, the medium having instructions to modify the program to expand a register set for a callee routine of the program.

23. The system of claim 22, the medium having instructions to modify the program to expand a register set for a caller routine that is to call the callee routine.

24. The system of claim 23, the medium having instructions to modify the program to expand a register set that includes one or more registers of the register set for the caller routine.

25. The system of claim 23, the medium having instructions to identify one or more register moves for the register set of the caller routine and to modify the program to perform the identified one or more register moves prior to or upon returning from the callee routine to the caller routine.

26. The system of claim 23, the medium having instructions to identify a register move from a register added to the register set for the caller routine to a register added to the register set for the callee routine and to modify the program to perform the identified register move.

27. The system of claim 19, the medium having instructions to modify the program to store and/or use data in one or more registers added to the register set to help analyze execution of the program.
